(19) United States
(12) Patent Application Publication
(10) Pub. No.: US 2024/0067028 A1
(43) Pub. Date: Feb. 29, 2024

(54) Power Management Apparatus, Power Management System, and Method for Providing Power Service

(71) Applicant: TOYOTA JIDOSHA KABUSHIKI KAISHA, Toyota-shi Aichi-ken (JP)

(72) Inventors: Osamu YUMITA, Seto-shi Aichi-ken (JP); Yoichi ONISHI, Okazaki-shi Aichi-ken (JP); Toru ANDO, Obu-shi Aichi-ken (JP); Ikuma SUZUKI, Okazaki-shi Aichi-ken (JP); Yu NAGATA, Chofu-shi Tokyo-to (JP)

(73) Assignee: TOYOTA JIDOSHA KABUSHIKI KAISHA, Toyota-shi Aichi-ken (JP)

(21) Appl. No.: 18/236,712

(22) Filed: Aug. 22, 2023

(30) Foreign Application Priority Data
Aug. 25, 2022 (JP) 2022-134266

(51) Int. Cl. B60L 53/63; B60L 55/00

(52) U.S. Cl. CPC B60L 53/63; B60L 55/00

(57) ABSTRACT

A power management apparatus includes a communication unit (acquisition unit) that acquires information about supply and demand of electric power for a power bank (power storage device), and a processor (controller) that controls electric power received by an electric vehicle from the power bank. The processor sets a power exchange ratio of electric power received from the power bank to electric power supplied to the power bank, depending on the supply and demand of electric power. The processor determines an amount of electric power to be received by the electric vehicle from the power bank, based on an amount of electric power supplied from the electric vehicle to the power bank, and the power exchange ratio.

### CROSS REFERENCE TO RELATED APPLICATIONS

This nonprovisional application is based on Japanese Patent Application No. 2022-134266 filed on Aug. 25, 2022 with the Japan Patent Office, the entire contents of which are hereby incorporated by reference.

### BACKGROUND

### Field

The present disclosure relates to a power management apparatus, a power management system, and a method for providing a power service.

### Description of the Background Art

Japanese Patent Laying-Open No. 2021-129441 discloses a server that controls charging and discharging of electric power between an electric vehicle and a charging-discharging station connected to each other. Supply and demand of electric power in an electric power grid is thus equalized by the charging and discharging.

### SUMMARY

The server disclosed in Japanese Patent Laying-Open No. 2021-129441 does not take it into account the fact that charging and discharging of electric power are performed based on the state of supply and demand of electric power in the electric power grid. This may make it difficult to equalize supply and demand of electric power. It is desired to facilitate equalization of supply and demand of electric power.

The present disclosure is made to solve the above problem, and an object of the present disclosure is to provide a power management apparatus, a power management system, and a method for providing a power service that enable easy equalization of supply and demand of electric power.

A power management apparatus according to a first aspect of the present disclosure is a power management apparatus that provides a power service to a user, the user having: a power supply capable of supplying electric power to a power storage device; and a load capable of receiving electric power from the power storage device, the power management apparatus including: an acquisition unit that acquires supply and demand of electric power for the power storage device; and a controller that controls electric power received by the load from the power storage device. The controller sets a power exchange ratio of electric power received from the power storage device to electric power supplied to the power storage device, depending on the supply and demand of electric power, and determines an amount of electric power to be received by the load from the power storage device, based on an amount of electric power supplied from the power supply to the power storage device, and the power exchange ratio.

In the power management apparatus according to the first aspect of the present disclosure, the amount of electric power to be received by the load from the power storage device is determined based on the power exchange ratio determined depending on the supply and demand of electric power. Thus, the amount of electric power to be withdrawn by an electric vehicle from the power storage device is set depending on the supply and demand of electric power. As a result, supply and demand of electric power can be equalized easily.

In the power management apparatus according to the first aspect, the controller reduces the amount of electric power to be received by the load from the power storage device, by setting the power exchange ratio lower as a shortage of electric power in the power storage device is larger. With such a configuration, the amount of electric power withdrawn by the electric vehicle from the power storage device can be reduced, when there is a shortage of electric power in the power storage device. As a result, supply and demand of electric power can be equalized easily when there is a shortage of electric power in the power storage device (demand for electric power exceeds supply of electric power).

In this case, the controller lessens a reduction of the power exchange ratio when an amount of electric power supplied from the power supply to the power storage device is larger than a predetermined first threshold value, relative to a reduction of the power exchange ratio when the amount of electric power supplied from the power supply to the power storage device is smaller than the first threshold value. With such a configuration, the amount of electric power withdrawable by a user supplying a relatively large amount of electric power to the power storage device can be prevented from being restricted excessively.

In the power management apparatus that lessens a reduction of the power exchange ratio when the amount of supplied electric power is larger than the first threshold value, the controller does not reduce the power exchange ratio, when the amount of electric power supplied from the power supply to the power storage device is larger than a second threshold value that is larger than the first threshold value. With such a configuration, the amount of electric power withdrawable by the user who supplies a relatively large amount of electric power to the power storage device can be prevented from being restricted excessively.

In the power management apparatus according to the first aspect, the acquisition unit acquires at least one piece of information among an amount of electric power stored in the power storage device, atmospheric temperature, and season. The controller determines the supply and demand of electric power based on the at least one piece of information. With such a configuration, the supply and demand of electric power can be determined easily based on at least one of the amount of electric power stored in the power storage device, the atmospheric temperature, and the season.

A management system according to a second aspect of the present disclosure includes a power storage device; and a power management apparatus that provides a power service to a user, the user having: a power supply capable of supplying electric power to the power storage device; and a load capable of receiving electric power from the power storage device. The power management apparatus includes: an acquisition unit that acquires supply and demand of electric power for the power storage device; and a controller that controls electric power received by the load from the power storage device. The controller sets a power exchange ratio of electric power received from the power storage device to electric power supplied to the power storage device, depending on the supply and demand of electric power, and determines an amount of electric power to be received by the load from the power storage device, based on an amount of electric power supplied from the power supply to the power storage device, and the power exchange ratio.

The management system according to the second aspect of the present disclosure determines the amount of electric power to be received by the load from the power storage device, based on the power exchange ratio which is set depending on the supply and demand of electric power. Thus, the management system capable of easily equalizing supply and demand of electric power can be provided.

A management method according to a third aspect of the present disclosure is a method for providing a power service to a user, the user having: a power supply capable of supplying electric power to a power storage device; and a load capable of receiving electric power from the power storage device, the method includes: acquiring supply and demand of electric power for the power storage device; and setting a power exchange ratio of electric power received from the power storage device to electric power supplied to the power storage device, depending on the supply and demand of electric power. The setting includes determining an amount of electric power to be received by the load from the power storage device, based on an amount of electric power supplied from the power supply to the power storage device, and the power exchange ratio.

With the management method according to the third aspect of the present disclosure, the amount of electric power to be received by the load from the power storage device is determined based on the power exchange ratio that is set depending on the supply and demand of electric power, as described above. Thus, a method for providing a power service that enables easy equalization of supply and demand of electric power can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 illustrates a configuration of a power management system according to one embodiment.

FIG. 2 illustrates a power exchange ratio in the event of no shortage of electric power (atmospheric temperature: 20° C.).

FIG. 3 illustrates a power exchange ratio in the event of shortage of electric power (atmospheric temperature: 20° C.).

FIG. 4 illustrates a state where a reduction of the power exchange ratio is lessened.

FIG. 5 illustrates a state where control or reducing the power exchange ratio is not performed.

FIG. 6 illustrates a power exchange ratio in the event of shortage of electric power (atmospheric temperature: 0° C.).

FIG. 7 is a sequence diagram illustrating a method for providing a power service by a power management system according to one embodiment.

FIG. 8 illustrates a configuration of a power management system according to a modification of one embodiment.

### DESCRIPTION OF THE EMBODIMENTS

Embodiments of the present disclosure are hereinafter described in detail with reference to the drawings. In the drawings, the same or corresponding parts are denoted by the same reference characters, and a description thereof is not herein repeated.

FIG. 1 illustrates a configuration of a power management system 1 according to an embodiment of the present disclosure. Power management system 1 includes a power management apparatus 100, a power bank 200, a plurality of electric vehicles 10, and a plurality of pieces of EVSE (Electric Vehicle Supply Equipment) 20. Only one electric vehicle 10 and only one piece of EVSE 20 may also be provided in power management system 1. Power bank 200 is one example of “power storage device” of the present disclosure. Electric vehicle 10 is one example of “power supply” and “load” of the present disclosure.

Electric vehicle 10 includes, for example, PHEV (Plug-in Hybrid Electric Vehicle), BEV (Battery Electric Vehicle), and FCEV (Fuel Cell Electric Vehicle). Electric vehicle 10 may also include DCM (Data Communication Module), or include a communication I/F adapted to 5G (fifth generation mobile communications system).

EVSE 20 means equipment for supplying electric power to vehicles. Electric vehicle 10 is configured to be electrically connectable to EVSE 20. For example, a charging cable 21 coupled to EVSE 20 is connected to an inlet of electric vehicle 10 to enable electric power to be supplied and received between EVSE 20 and electric vehicle 10.

Electric vehicle 10 can supply electric power to power bank 200. Electric vehicle 10 can also receive electric power from power bank 200. Specifically, electric vehicle 10 can be electrically connected to EVSE 20 to supply and receive electric power as described above. Electric vehicle 10 may supply electric power and receive electric power to and from the same EVSE 20, or different pieces of EVSE 20.

Power management apparatus 100 is an apparatus providing power service to a user having electric vehicle 10. Power management apparatus 100 is configured to manage information about a plurality of registered electric vehicles 10 (hereinafter also referred to as “vehicle information”), information about each registered user (hereinafter also referred to as “user information”), and information about registered EVSE 20 (hereinafter also referred to as “EVSE information”). The user information, the vehicle information and the EVSE information are distinguished from each other by identification information (ID) and stored in a memory 102 described later herein.

User ID is identification information for identifying a user, and also serves as information for identifying a mobile terminal (not shown) carried by the user (terminal ID). Power management apparatus 100 is configured to distinguish and store, for each user ID, information received from a mobile terminal. The user information includes a communication address of a mobile terminal carried by the user, and a vehicle ID of electric vehicle 10 belonging to the user.

The vehicle ID is identification information for identifying electric vehicle 10. The vehicle ID may also be license plate or VIN (Vehicle Identification Number). The vehicle information includes an activity plan of each electric vehicle 10.

The EVSE-ID is identification information for identifying EVSE 20. The EVSE information includes a communication address of each EVSE 20 and the state of electric vehicle 10 connected to each EVSE 20. The EVSE information also includes information indicating a combination of electric vehicle 10 and EVSE 20 connected to each other (a combination of EVSE-ID and vehicle ID, for example).

A user of electric vehicle 10 can store (deposit) electric power that the user has supplied to power bank 200, for dedicated use by the user. From power bank 200, the user can receive (withdraw), at free of charge, the electric power for dedicated use by the user.

The user of electric vehicle 10 can also store, in power bank 200, electric power that the user has supplied to power bank 200, for shared use by the user and other users as well. The user can supply to power bank 200 the aforementioned electric power for shared use, to obtain an incentive such as money and/or points.

The amount of electric power in the whole power bank 200 is the sum of respective amounts of electric power stored by respective users for the users' dedicated use, and the amount of electric power for the shared use.

Power management apparatus 100 includes a processor 101, a memory 102, and a communication unit 103. Processor 101 and communication unit 103 are an example of “controller” and an example of “acquisition unit” of the present disclosure, respectively.

Memory 102 stores a program to be executed by processor 101, as well as information (map, mathematic expression, and various parameters, for example) to be used for the program. Communication unit 103 includes various communication I/Fs. Processor 101 controls communication unit 103. Specifically, processor 101 communicates, through communication unit 103, with power bank 200, a DCM (or user's mobile terminal) of electric vehicle 10, and EVSE 20.

Communication unit 103 acquires information about supply and demand of electric power for power bank 200. Specifically, communication unit 103 acquires, from power bank 200 through communication, information about the amount of electric power stored in power bank 200. Communication unit 103 also acquires, from power bank 200 for example, information about the amount of electric power stored by the user in power bank 200 for the user's dedicated use (the amount of electric power supplied by the user). Communication unit 103 also acquires, through communication from a temperature sensor, a weather prediction center, or the like (not shown), information about the atmospheric temperature.

Processor 101 determines supply and demand of electric power for power bank 200, based on information about the amount of electric power stored in power bank 200 as well as information about the atmospheric temperature that are acquired through communication unit 103.

The conventional system does not take into account the fact that charging and discharging of electric power are performed based on the state of supply and demand of electric power in the electric power grid (power bank). This may make it difficult to equalize supply and demand of electric power. It is desired to easily equalize supply and demand of electric power.

In view of the above, in the present embodiment, processor 101 sets the power exchange ratio of electric power received from power bank 200, to the electric power supplied to power bank 200, depending on the supply and demand of electric power. Based on the amount of electric power supplied from electric vehicle 10 to power bank 200 and the power exchange ratio, processor 101 determines the amount of electric power to be received by electric vehicle 10 from power bank 200. In other words, based on the amount of supplied electric power and the power exchange ratio, processor 101 sets the upper limit of the amount of electric power that electric vehicle 10 can receive from power bank 200.

<In the Event of No Electric Power Shortage/Appropriate Temperature>

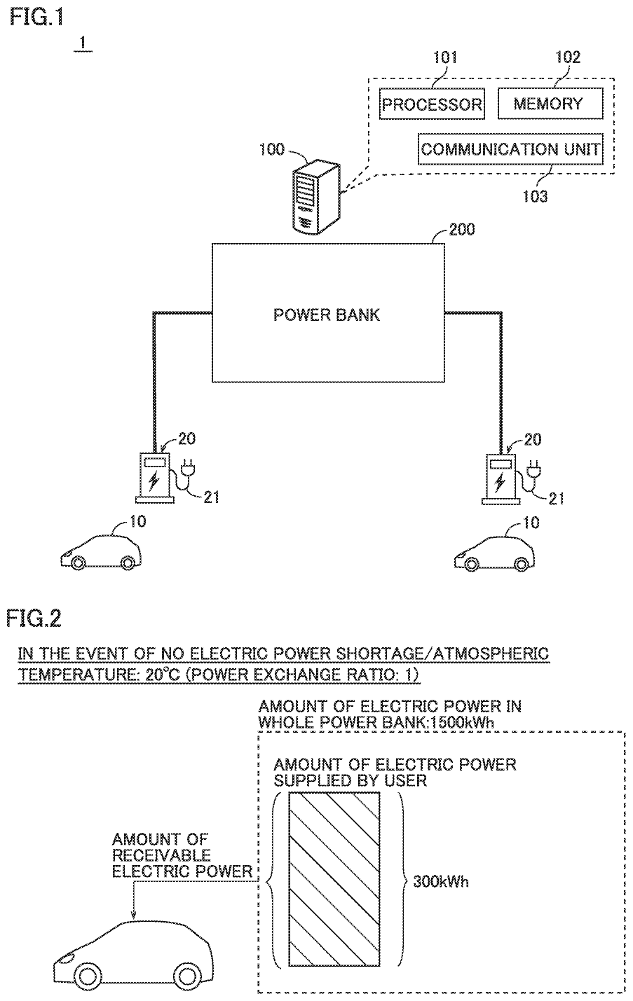

FIG. 2 illustrates an example where there is no shortage of electric power due to the fact that an electric power amount of 1500 kWh is stored in the whole power bank 200, and the atmospheric temperature is an appropriate temperature (20° C. for example). In this example, processor 101 determines that demand for electric power does not exceed supply of electric power for power bank 200 (there is sufficient electric power).

In this case, processor 101 sets the power exchange ratio to 1. It is supposed here that a user of electric vehicle 10 has stored 300 kW in power bank 200 as an amount of electric power for the user's dedicated use (the amount of electric power supplied by the user). In this case, the user of electric vehicle 10 can receive (withdraw) from power bank 200 an amount of electric power (300 kWh) that is one time as large as 300 kWh.

As the shortage of electric power in power bank 200 is larger (the power demand exceeds the power supply to a greater extent), processor 101 sets the power exchange ratio lower, so as to reduce the amount of electric power to be received by electric vehicle 10 from power bank 200.

<In the Event of Electric Power Shortage/Appropriate Temperature>

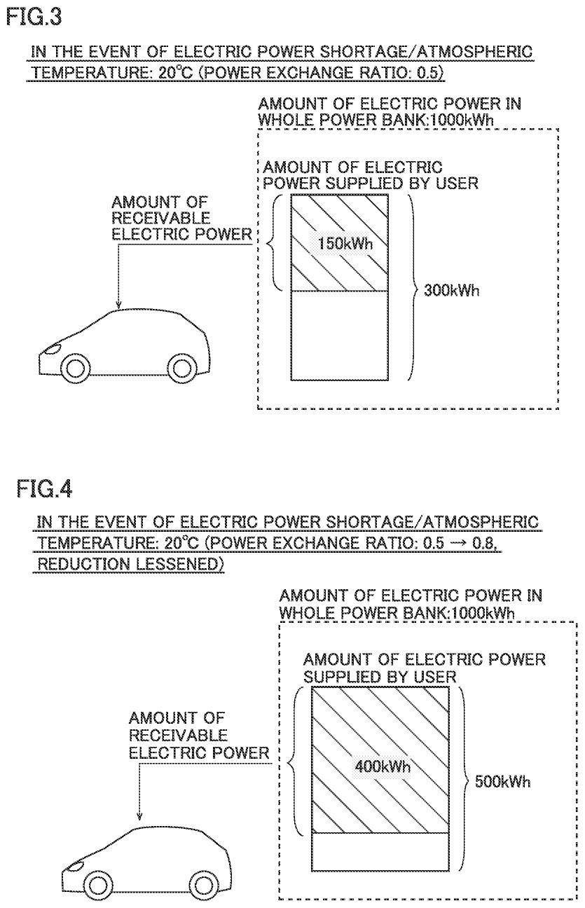

FIG. 3 illustrates an example where there is a shortage of electric power due to the fact that only an electric power amount of 1000 kWh is stored in the whole power bank 200, and the atmospheric temperature is 20° C. In this example, processor 101 determines that the power demand exceeds the power supply for power bank 200 to a greater extent (there is a greater shortage of electric power) relative to the example shown in FIG. 2.

In this case, processor 101 reduces the power exchange ratio to a smaller value (0.5, for example) than 1. Similarly to FIG. 2, it is supposed here that a user of electric vehicle 10 has stored 300 kW in power bank 200 as an amount of electric power for the user's dedicated use (the amount of electric power supplied by the user). In this case, the user of electric vehicle 10 can receive (withdraw) from power bank 200 an amount of electric power (150 kWh) that is 0.5 times as large as 300 kWh.

While FIGS. 2 and 3 each illustrate an example where the power exchange ratio is set lower than 1 when the power demand exceeds the power supply for power bank 200, the present disclosure is not limited to this. For example, the power exchange ratio may be set higher than 1 when there is sufficient electric power to be supplied (there is a surplus electric power stored in power bank 200).

<Threshold Value for Amount of Supplied Electric Power>

When the amount of electric power supplied from electric vehicle 10 to power bank 200 is larger than a predetermined first threshold value, processor 101 lessens the reduction of the power exchange ratio, relative to the case where the amount of electric power supplied from electric vehicle 10 to power bank 200 is smaller than the first threshold value.

FIG. 4 illustrates an example, similar to the example shown in FIG. 3, where there is a shortage of electric power due to the fact that an amount of electric power of 1000 kWh is stored in the whole power bank 200, and the atmospheric temperature is 20° C. In the example shown in FIG. 4, the amount of electric power (500 kWh) supplied from electric vehicle 10 is larger than the amount of supplied electric power (300 kWh) in the example shown in FIG. 3.

It is supposed here that the first threshold value is 400 kWh, for example. The amount of electric power supplied from electric vehicle 10 is larger than the first threshold value. In this case, processor 101 sets the power exchange ratio to 0.8 that is higher than the power exchange ratio (0.5) in the example shown in FIG. 3, to thereby lessen the reduction of the power exchange ratio. As a result, a user of electric vehicle 10 can receive (withdraw) from power bank 200 an amount of electric power (400 kWh) that is 0.8 times as large as 500 kWh.

When the amount of electric power supplied from electric vehicle 10 to power bank 200 is still larger than a second threshold value that is larger than the first threshold value, processor 101 does not reduce the power exchange ratio.

FIG. 5 illustrates an example, like the example shown in FIG. 3 (and FIG. 4), where there is a shortage of electric power due to the fact that an amount of electric power of 1000 kWh is stored in the whole power bank 200, and the atmospheric temperature is 20° C. In the example shown in FIG. 5, the amount of electric power (750 kWh) supplied from electric vehicle 10 is larger than the amount of supplied electric power (500 kWh) in the example shown in FIG. 4.

It is supposed here that the second threshold value is 700 kWh, for example. In this case, processor 101 sets the power exchange ratio to 1. In other words, processor 101 does not perform the control of reducing the power exchange ratio. As a result, a user of electric vehicle 10 can receive (withdraw) from power bank 200 an amount of electric power (750 kWh) that is one time as large as 750 kWh.

<In the Event of Temperature Decrease>

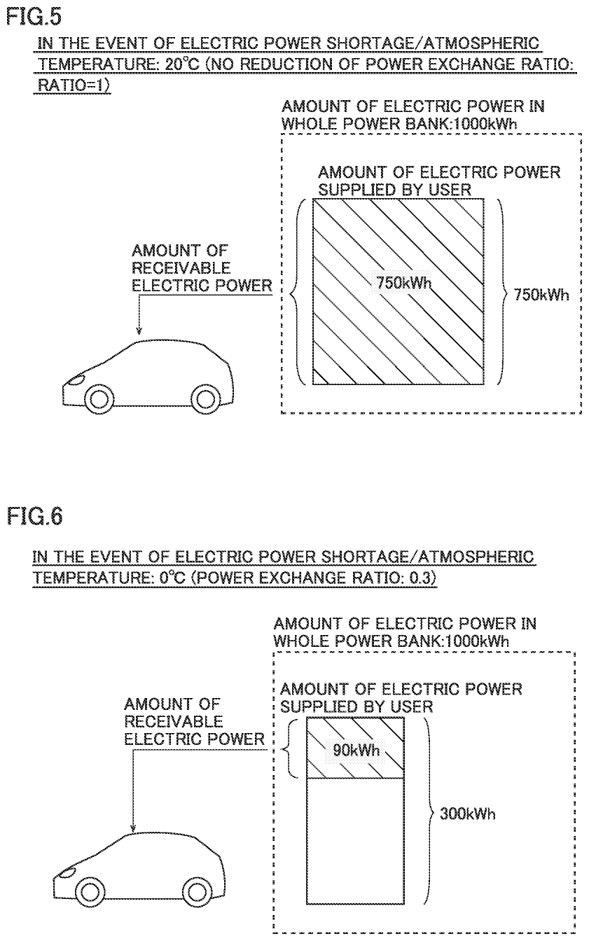

In the example shown in FIG. 6, like the example shown in FIG. 3, there is a shortage of electric power due to the fact that an amount of electric power of 1000 kWh is stored in the whole power bank 200. Meanwhile, the atmospheric temperature in the example shown in FIG. 6 is a lower temperature (0° C.) than the atmospheric temperature (20° C.) in the example shown in FIG. 3. In this case, processor 101 determines that the demand for electric power in power bank 200 exceeds its supply to a greater extent (there is a greater shortage of electric power) than the example shown in FIG. 3.

In the example shown in FIG. 6, processor 101 sets the power exchange ratio to a lower value (0.3 for example) than the power exchange ratio (0.5) in the example shown in FIG. 3. As a result, a user of electric vehicle 10 can receive (withdraw) from power bank 200 an amount of electric power (90 kWh) that is 0.3 times as large as 300 kWh.

The above-described stepwise change of the power exchange ratio is merely an example. For example, the power exchange ratio may be changed linearly (successively) based on the atmospheric temperature, the amount of electric power supplied from the user, and the amount of electric power in the whole power bank 200, for example. The power exchange ratio may be reduced, for example, proportionally to the decrease of the atmospheric temperature.

(Method for Providing Power Service)

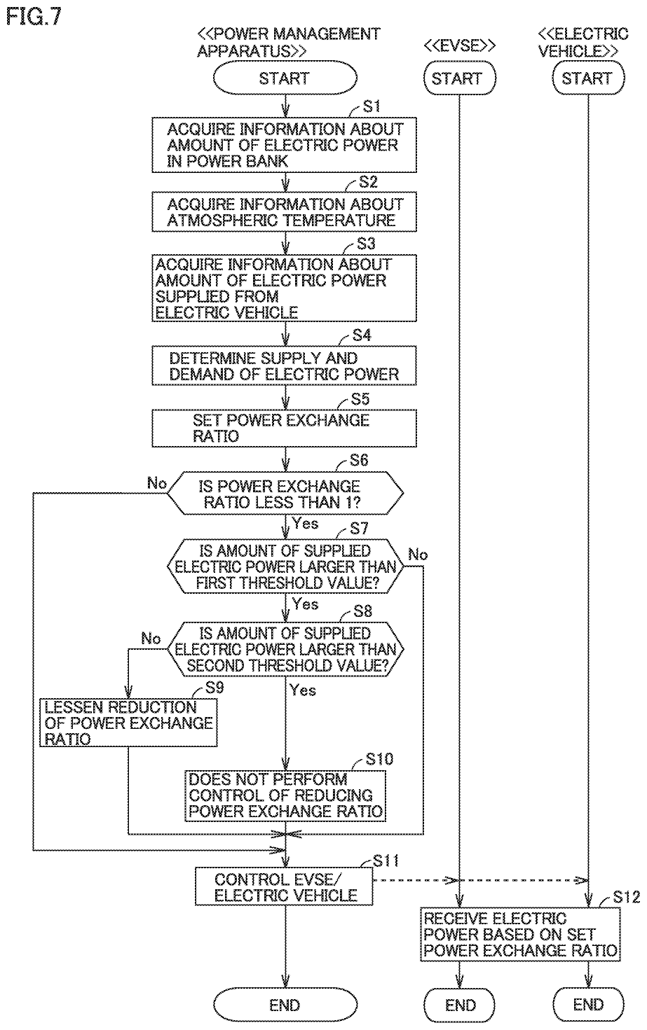

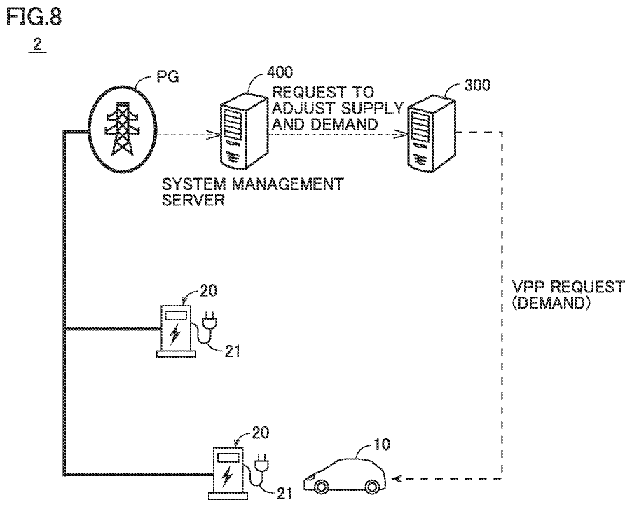

Next, with reference to a sequence diagram in FIG. 7, a method for providing a power service by power management apparatus 100 is described.

In step S1, power management apparatus 100 acquires information about the amount of electric power in power bank 200, from power bank 200 through communication unit 103.

In step S2, power management apparatus 100 acquires information about the atmospheric temperature from a temperature sensor, a weather forecast center, or the like (not shown) through communication unit 103. The temperature sensor may be included in power management apparatus 100. The operation in step S2 may be performed before the operation in step S1, or may be performed simultaneously with the operation in step S1.

In step S3, power management apparatus 100 acquires, from power bank 200, information about the amount of electric power supplied to power bank 200 by electric vehicle 10 (the amount of electric power for each user's dedicated use). The information about the amount of supplied electric power may be updated each time electric vehicle 10 supplies electric power and receives electric power, and may be managed in memory 102.

In step S4, processor 101 determines supply and demand of electric power for power bank 200, based on the information in steps S1 and S2.

In step S5, processor 101 sets the power exchange ratio, which is the ratio of the electric power received from power bank 200 to the electric power supplied to power bank 200, based on the supply and demand of electric power determined in step S4. Specifically, when it is determined in step S4 that the demand for electric power exceeds the supply of electric power (there is a shortage of electric power stored in power bank 200) (see FIG. 3 for example), the power exchange ratio is set to a value smaller than 1. In contrast, when it is determined that there is sufficient electric power to be supplied (there is a surplus of electric power stored in power bank 200), the power exchange ratio is set to a value higher than 1.

In step S6, processor 101 determines whether or not the power exchange ratio set in step S5 is less than 1. When the power exchange ratio is less than 1 (Yes in S6), the process proceeds to step S7. When the power exchange ratio is 1 or more (No in S6), the process proceeds to step S11.

In step S7, processor 101 determines whether or not the amount of electric power supplied from electric vehicle 10 to power bank 200 is larger than the first threshold value (400 kWh, for example). When the amount of supplied electric power is larger than the first threshold value (Yes in S7), the process proceeds to step S8. When the amount of supplied electric power is the first threshold value or less (No in S7), the process proceeds to step S11.

In step S8, processor 101 determines whether or not the amount of electric power supplied from electric vehicle 10 to power bank 200 is larger than the second threshold value (700 kWh, for example). When the amount of supplied electric power is larger than the second threshold value (Yes in S8), the process proceeds to step S10. When the amount of supplied electric power is the second threshold or less (No in S8), the process proceeds to step S9.

In step S9, processor 101 lessens the reduction of the power exchange ratio. Thus, the power exchange ratio is set to a value higher than the value set in step S5 and lower than 1.

In step S9, processor 101 may change the degree to which the reduction of the ratio is lessened, based on the amount of electric power supplied by electric vehicle 10. Specifically, processor 101 may increase the degree to which the reduction of the ratio is lessened, as the amount of supplied electric power is larger. The degree to which the reduction is lessened may also be constant, regardless of the amount of supplied electric power.

In step S10, processor 101 does not perform the control of reducing the power exchange ratio. Specifically, processor 101 sets the power exchange ratio to 1, regardless of the value of the power exchange ratio that is set (reduced) in step S5.

In step S11, processor 101 controls EVSE 20 and electric vehicle 10 such that the upper limit of the amount of electric power received by electric vehicle 10 from power bank 200 is determined based on the set power exchange ratio.

In step S12, electric power is supplied and received between electric vehicle 10 and EVSE 20, in the state where the upper limit of the amount of electric power to be received by electric vehicle 10 is set based on the set power exchange ratio.

Thus, in the present embodiment, processor 101 sets the power exchange ratio of electric power received from power bank 200 to electric power supplied to power bank 200, depending on the supply and demand of electric power for power bank 200. Processor 101 then determines the amount of electric power to be received by electric vehicle 10 from power bank 200, based on the amount of electric power supplied from electric vehicle 10 to power bank 200 and the power exchange ratio. In this way, the power exchange ratio is set and the amount of electric power to be received is adjusted, depending on the supply and demand of electric power for power bank 200. As a result, the amount of electric power to be received is prevented from becoming relatively larger when the demand for electric power exceeds the supply of electric power, for example. In this way, supply and demand of electric power can be equalized easily.

A user of electric vehicle 10 who has provided a relatively large amount of electric power to power bank 200 can receive a relatively large amount of electric power, since the power exchange ratio is set relatively higher.

While an example is illustrated in the above embodiment where electric vehicle 10 receives electric power from power bank 200, the present disclosure is not limited to this. Electric vehicle 10 may also receive electric power from an electric power system PG. A specific description is given below with reference to FIG. 8.

FIG. 8 illustrates a configuration of a power management system 2 according to a modification of the above embodiment. Power management system 2 includes a power management apparatus 300, an electric power system PG, a system management server 400, an electric vehicle 10, and an EVSE 20. Electric power system PG is one example of “power storage device” in the present disclosure.

System management server 400 manages supply and demand of electric power for electric power system PG (electric power grid). System management server 400 transmits, to power management apparatus 300, a request to adjust the supplied amount and the received amount of electric power of electric power system PG (request to adjust supply and demand) based on the generated power and the power consumption by each power adjustment resource managed by system management server 400.

Power management apparatus 300 requests electric vehicle 10 to supply electric power to electric power system PG (external supply) or to be charged from electric power system PG (external charging), as a technique for increasing or decreasing the supplied electric power/the received electric power of electric power system PG.

Unlike the above embodiment, power management apparatus 300 acquires information about the state of electric power in electric power system PG, based on the information (the request to adjust supply and demand) from system management server 400. Power management apparatus 300 then determines supply and demand of electric power for electric power system PG, based on the state of electric power in electric power system PG and the atmospheric temperature. Control other than the above-described one is similar to the above embodiment, and therefore, the description thereof is not herein repeated.

While an example is illustrated in the above embodiment where the first threshold value and the second threshold value are set for the amount of electric power supplied by the user, the present disclosure is not limited to this. Only one of the first threshold value and the second threshold value may also be set. In other words, only one of the control of lessening the reduction of the power exchange ratio, and the control of not lessening the reduction of the power exchange ratio may also be performed.

While an example is illustrated in the above embodiment where supply and demand of electric power for power bank 200 are determined based on the amount of electric power in power bank 200 and the atmospheric temperature, the present disclosure is not limited to this. Supply and demand of electric power may be determined based on the amount of electric power in power bank 200 and the season. For example, it may be determined that the electric power demand exceeds its supply to a greater extent in winter, relative to other seasons (summer, for example). Supply and demand of electric power may also be determined, based on any one of the amount of electric power in power bank 200, the atmospheric temperature, and the season, or based on all of the amount of electric power, the atmospheric temperature, and the season.

The power exchange ratio may also be set based on the SOC (State Of Charge) of electric vehicle 10. For example, the power exchange ratio may be reduced when the SOC of electric vehicle 10 is relatively low.

While an example is illustrated in the above embodiment where the power exchange ratio is adjusted based on the amount of electric power supplied to power bank 200, the present disclosure is not limited to this. For example, the power exchange ratio may be adjusted based on the frequency at which electric power is supplied from electric vehicle 10 to power bank 200. Specifically, when the frequency at which electric power is supplied to power bank 200 is relatively high, the reduction of the power exchange ratio may be lessened.

While an example is illustrated in the above embodiment where electric vehicle 10 supplies electric power to power bank 200 and electric vehicle 10 also receives electric power from power bank 200, the present disclosure is not limited to this. An electrical device (home power generator, for example) other than electric vehicle 10 may supply electric power to power bank 200 and this electrical device may also receive electric power from power bank 200. The electrical device supplying electric power to power bank 200 may be different from the electrical device receiving electric power from power bank 200.

It should be construed that embodiments disclosed herein are given by way of illustration in all respects, not by way of limitation. It is intended that the scope of the present disclosure is defined by claims, and encompasses all modifications equivalent in meaning and scope to the claims.

What is claimed is:

1. A power management apparatus that provides a power service to a user, the user having: a power supply capable of supplying electric power to a power storage device; and a load capable of receiving electric power from the power storage device, the power management apparatus comprising:
an acquisition unit that acquires information about supply and demand of electric power for the power storage device; and
a controller that controls electric power received by the load from the power storage device, wherein
the controller
sets a power exchange ratio of electric power received from the power storage device to electric power supplied to the power storage device, depending on the supply and demand of electric power, and
determines an amount of electric power to be received by the load from the power storage device, based on an amount of electric power supplied from the power supply to the power storage device, and the power exchange ratio.

2. The power management apparatus according to claim 1, wherein the controller reduces the amount of electric power to be received by the load from the power storage device, by setting the power exchange ratio lower as a shortage of electric power in the power storage device is larger.

3. The power management apparatus according to claim 2, wherein the controller lessens a reduction of the power exchange ratio when the amount of electric power supplied from the power supply to the power storage device is larger than a predetermined first threshold value, relative to a reduction of the power exchange ratio when the amount of electric power supplied from the power supply to the power storage device is smaller than the first threshold value.

4. The power management apparatus according to claim 3, wherein the controller does not reduce the power exchange ratio, when the amount of electric power supplied from the power supply to the power storage device is larger than a second threshold value that is larger than the first threshold value.

5. The power management apparatus according to claim 1, wherein
the acquisition unit acquires at least one piece of information among an amount of electric power stored in the power storage device, atmospheric temperature, and season, and
the controller determines the supply and demand of electric power based on the at least one piece of information.

6. A power management system comprising:
a power storage device; and
a power management apparatus that provides a power service to a user, the user having: a power supply capable of supplying electric power to the power storage device; and a load capable of receiving electric power from the power storage device,
the power management apparatus comprising:
an acquisition unit that acquires information about supply and demand of electric power for the power storage device; and
a controller that controls electric power received by the load from the power storage device, wherein
the controller
sets a power exchange ratio of electric power received from the power storage device to electric power supplied to the power storage device, depending on the supply and demand of electric power, and
determines an amount of electric power to be received by the load from the power storage device, based on an amount of electric power supplied from the power supply to the power storage device, and the power exchange ratio.

7. A method for providing a power service to a user, the user having: a power supply capable of supplying electric power to a power storage device; and a load capable of receiving electric power from the power storage device, the method comprising:
acquiring information about supply and demand of electric power for the power storage device; and
setting a power exchange ratio of electric power received from the power storage device to electric power supplied to the power storage device, depending on the supply and demand of electric power, wherein
the setting includes determining an amount of electric power to be received by the load from the power storage device, based on an amount of electric power supplied from the power supply to the power storage device, and the power exchange ratio.
